(19) United States
(12) Patent Application Publication
(10) Pub. No.: US 2015/0166046 A1
(43) Pub. Date: Jun. 18, 2015

(54) VEHICLE CONTROL APPARATUS

(71) Applicant: TOYOTA JIDOSHA KABUSHIKI KAISHA, Toyota-shi (JP)

(72) Inventors: Yumi KONDO, Toyota-shi (JP); Hiroaki TABUCHI, Toyota-shi (JP)

(73) Assignee: TOYOTA JIDOSHA KABUSHIKI KAISHA, Toyota-shi (JP)

(21) Appl. No.: 14/535,954

(22) Filed: Nov. 7, 2014

(30) Foreign Application Priority Data
Dec. 18, 2013 (JP) 2013-261737

(51) Int. Cl. B60W 20/00

(52) U.S. Cl. CPC B60W 20/106

(57) ABSTRACT

A vehicle control apparatus is disclosed, which includes: a sensor that obtains information representing a status of a degradation degree of a battery; a controller that permits at least one of a charge control and an idling stop control such that the degradation degree of the battery does not affect a way of performing the control, until a predetermined parameter that affects a life of the battery meets a control prevention condition, the charge control controlling an alternator according to a travel state of a vehicle, wherein the control prevention condition is varied according to the degradation degree of the battery such that the control prevention condition becomes more difficult to be met as the degradation degree of the battery becomes higher.

### FIELD

The disclosure is related to a vehicle control apparatus.

### BACKGROUND

Japanese Laid-open Patent Publication No. 2011-189768 (referred to as “Patent Document 1” hereinafter) discloses such a configuration in a hybrid vehicle in which a current-limiting value of charging and discharging is set according to a charged state, a limit value is set to charging electrical capacity at a charging operation in one procedure, and then charging is controlled so as not to exceed the limit value, wherein supposed deterioration characteristics is compared with real deterioration, then the current-limiting value or a charging electric capacity limit value is changed based on a result of the comparison.

In the case of a configuration in which a fuel economy control such as a charge control for controlling an alternator according to a travel state of a vehicle, an idling stop control, etc., is performed, it is useful, in terms of enhancing the fuel economy, to perform the fuel economy control as usual while reserving life of the battery.

In this connection, for example, according to the configuration disclosed in Patent Document 1, the charging electric capacity limit value for the charging operation at the time of regeneration, for example, is changed based on a result of the comparison between the supposed deterioration characteristics and the real deterioration. Thus, there may be a case where the charging operation cannot be performed as usual and thus the fuel economy cannot be increased efficiently.

Therefore, an object of the disclosure is to provide a vehicle control apparatus that can perform a fuel economy control, such as a charge control for controlling an alternator according to a travel state of a vehicle, and an idling stop control as usual in performing the fuel economy control while reserving life of a battery.

### SUMMARY

According to one aspect of the disclosure, a vehicle control apparatus is disclosed, which includes: a sensor that obtains information representing a status of a degradation degree of a battery; a controller that permits at least one of a charge control and an idling stop control such that the degradation degree of the battery does not affect a way of performing the control, until a predetermined parameter that affects a life of the battery meets a control prevention condition, the charge control controlling an alternator according to a travel state of a vehicle, wherein the control prevention condition is varied according to the degradation degree of the battery such that the control prevention condition becomes more difficult to be met as the degradation degree of the battery becomes higher.

### BRIEF DESCRIPTION OF DRAWINGS

FIG. 1 is a diagram illustrating a configuration of a power supply system of a vehicle according an embodiment.

FIG. 2 is a diagram illustrating a system configuration of a control system of a vehicle according an embodiment.

FIG. 3 is an example of a flowchart of a process executed by a charge control ECU 10.

FIG. 4 is a diagram explaining a process illustrated in FIG. 3.

### DESCRIPTION OF EMBODIMENTS

In the following, embodiments are described in detail with reference to appended drawings.

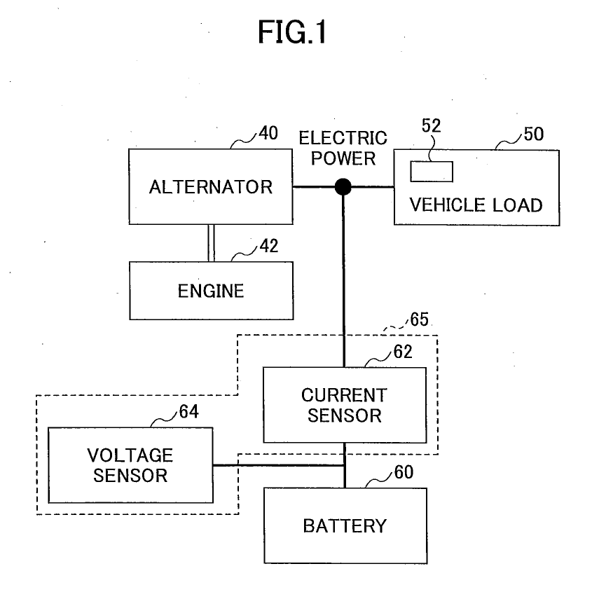

FIG. 1 is a diagram for illustrating a configuration of a power supply system of a vehicle according an embodiment. The embodiment is suited for the vehicle that installs only an engine (i.e., other than hybrid vehicles and electric vehicles). In a configuration illustrated in FIG. 1, an alternator 40 is mechanically connected to an engine 42. The alternator 40 is a generator that generates electricity based on the power of the engine 42. The electric power generated by the alternator 40 is utilized for charging a battery 60 and driving vehicle loads 50. It is noted that a current sensor 62 is provided for the battery 60. The current sensor 62 detects a battery current (i.e., a charge current to the battery 60 and a discharge current from the battery 60). Typically, the battery 60 is a lead acid battery; however, other types of batteries (or capacitors) may be used. A voltage sensor 64 is provided for the battery 60. It is noted that the voltage sensor 64 and the current sensor 62 may be formed by a single sensor unit 65 in which the voltage sensor 64 and the current sensor 62 are incorporated together with a processor (a microcomputer, for example). Further, the current sensor 62 may be a shunt resistance, for example, and the voltage may be calculated based on a product of the current value detected by the current sensor 62 and a resistance value of the shunt resistance. In this case, the current sensor 62 also serves as the voltage sensor 64. The vehicle loads 50 are arbitrary, and includes a starter 52, an air conditioner, a wiper, etc. In such a configuration, by controlling a voltage generated by the alternator 40, a SOC (State Of Charge) of the battery 60 can be controlled.

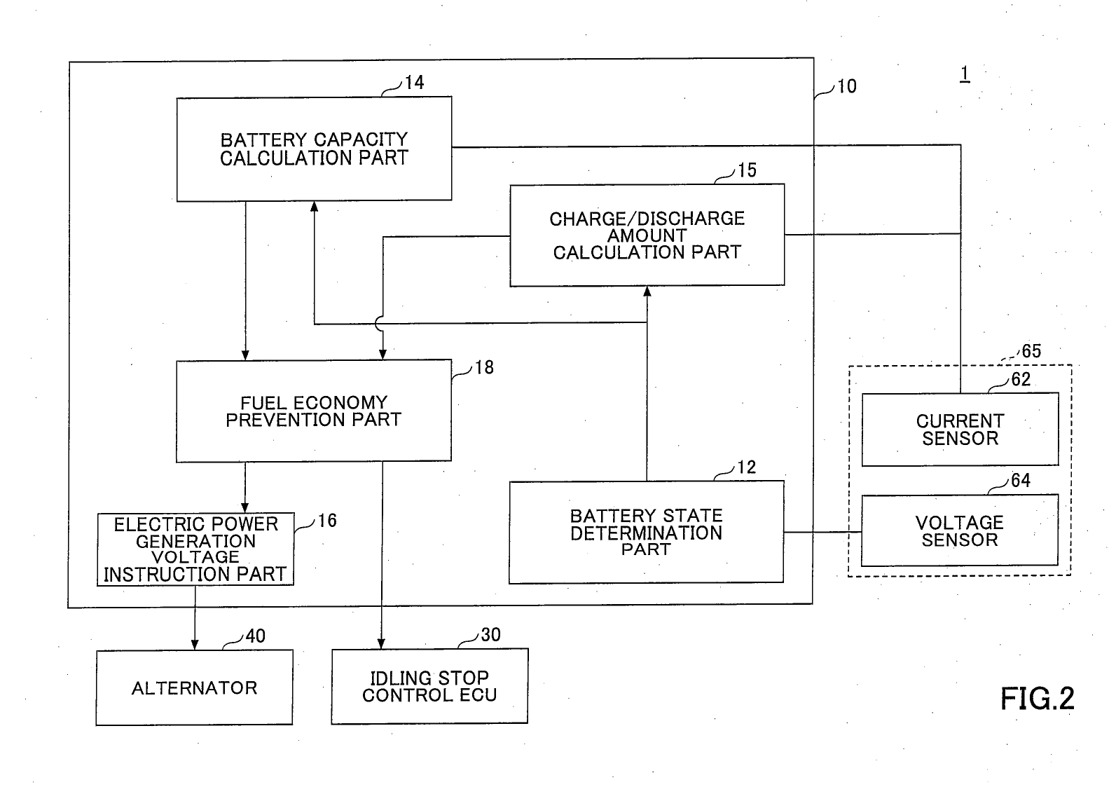

FIG. 2 is a diagram illustrating a system configuration of a control system of a vehicle according an embodiment.

A control system 1 includes a charge control ECU (Electronic Control Unit) 10 and an idling stop control ECU 30. It is noted that connection ways between elements in FIG. 2 are arbitrary. For example, the connection ways may include a connection via a bus such as a CAN (controller area network), etc., an indirect connection via another ECU, etc., a direct connection, and a connection that enables wireless communication. It is noted that sections of the functions of the ECUs are arbitrary, and a part or all of the functions of a particular ECU may be implemented by another ECU (which may include an ECU not illustrated). For example, a part or all of the functions of the charge control ECU 10 may be implemented by the idling stop control ECU 30, or conversely a part or all of the functions of the idling stop control ECU 30 may be implemented by the charge control ECU 10.

The charge control ECU 10 may be implemented by an engine ECU for controlling the engine, for example. The charge control ECU 10 includes a battery state determination part 12, a battery capacity calculation part 14, a charge/discharge amount calculation part 15, a electric power generation voltage instruction part 16 and a fuel economy prevention part 18, as illustrated in FIG. 2. It is noted that these parts merely represent imaginary functions implemented by software resources, and the sections are also arbitrary. Thus, a part of or all of a program that implements the battery state determination part 12, for example, may be incorporated into a program that implements the charge/discharge amount calculation part 15.

The battery state determination part 12 determines a degradation degree of the battery 60. Ways of determining the degradation degree of the battery 60 are various, and an arbitrary way may be used. For example, the degradation degree of the battery 60 is related to an internal resistance of the battery 60, and thus the degradation degree of the battery 60 may be calculated according to the internal resistance of the battery 60. Ways of calculating the internal resistance of the battery 60 are various, and an arbitrary way may be used. In this example, the battery state determination part 12 detects a battery voltage at the time of the engine start based on information from the voltage sensor 64, and determines the degradation degree of the battery 60 according to the battery voltage at the time of the engine start. This is because the degradation degree of the battery 60 affects the battery voltage at the time of the engine start. Typically, the higher the degradation degree of the battery 60 becomes, the lower the battery voltage at the time of the engine start becomes. In the following, as an example, it is assumed that the degradation degree is determined with n+1 steps (n is greater than or equal to 2) such that the greater k becomes, the higher the degradation degree becomes, wherein a degradation level “0” represents a state in which the degradation degree is minimum (the degradation does not occur, for example).

The battery capacity calculation part 14 calculates the current SOC of the battery 60 based on the detection values of the current sensor 62, etc. A concrete way of calculating the SOC of the battery 60 may be arbitrary. For example, the current SOC of the battery 60 can be calculated based on the SOC of the battery 60 at the time of an ignition switch ON event and a difference between a charge amount of electricity and a discharge amount of electricity after the time of the ignition switch ON event. Further, a temperature of the battery 60 may be considered to calculate the SOC of the battery 60.

The charge/discharge amount calculation part 15 calculates a cumulative charge/discharge electricity amount based on the detection values of the current sensor 62. The cumulative charge/discharge electricity amount may be a time-integrated value of the charge current and the discharge current such that the charge current and the discharge current are integrated with absolute values thereof. In the following, as an example, it is assumed that the charge/discharge amount calculation part 15 calculates the cumulative charge/discharge electricity amount from the time of the ignition switch ON event. In other words, the cumulative charge/discharge electricity amount is reset to an initial value 0 when the ignition switch is turned off.

The electric power generation voltage instruction part 16 determines an electric power generation voltage (target value) of the alternator 40 based on a vehicle travel state and the SOC of the battery 60 calculated by the battery capacity calculation part 14, under a situation where a charge control is not prevented by the fuel economy prevention part 18 as described hereinafter. The vehicle travel state includes a vehicle stop state, an accelerated state, a constant vehicle speed state, a decelerated state, etc., for example. A way of determining the electric power generation voltage of the alternator 40 according to the vehicle travel state is arbitrary. For example, in the constant vehicle speed state in which the vehicle speed is substantially constant, the electric power generation voltage instruction part 16 instructs the electric power generation voltage of the alternator 40 such that the SOC of the battery 60 is kept at a constant value α (less than 100%). Further, in the accelerated state, the electric power generation voltage instruction part 16 stops the electric power generation of the alternator 40 to increase an accelerating ability. In the decelerated state, the electric power generation voltage instruction part 16 performs an electric power regenerating operation of the alternator 40. It is noted that, when an idling stop control is performed in the vehicle stop state, the alternator 40 is stopped during a period in which the idling stop control is being performed.

The electric power generation voltage instruction part 16 instructs a predetermined constant value as the electric power generation voltage of the alternator 40, regardless of the vehicle travel state, etc., in a situation where the charge control is prevented by the fuel economy prevention part 18 as described hereinafter. The predetermined constant value may be set such that the battery 60 is brought to its full charged state and kept in the full charged state, for example. Alternatively, the electric power generation voltage instruction part 16 may instruct the electric power generation voltage of the alternator 40 such that the SOC of the battery 60 calculated by the battery capacity calculation part 14 becomes 100%.

The fuel economy prevention part 18 determines, based on the degradation degree of the battery 60 determined by the battery state determination part 12, the SOC of the battery 60 calculated by the battery capacity calculation part 14 and the cumulative charge/discharge electricity amount calculated by the charge/discharge amount calculation part 15, whether to permit a fuel economy control. The fuel economy control is performed for the purpose of increasing the fuel economy. The fuel economy control includes a charge control and an idling stop (Stop and Start) control, in this example. The fuel economy prevention part 18 prevents the charge control and the idling stop control by the idling stop control ECU 30. The detail of the fuel economy prevention part 18 is described hereinafter.

The idling stop control ECU 30 performs the idling stop control. The detail of the idling stop control is arbitrary. Typically, the idling stop control stops the engine 42 when a predetermined idling stop start condition is met in the vehicle stop state or the decelerated state in a low-speed range, and then restarts the engine 42 when a predetermined idling stop end condition is met. The predetermined idling stop start condition includes a condition that a prevention instruction is not output from the fuel economy prevention part 18. In other words, when the prevention instruction is generated by the fuel economy prevention part 18, the idling stop control is prevented and thus is not performed. A logic for generating the prevention instruction is described hereinafter.

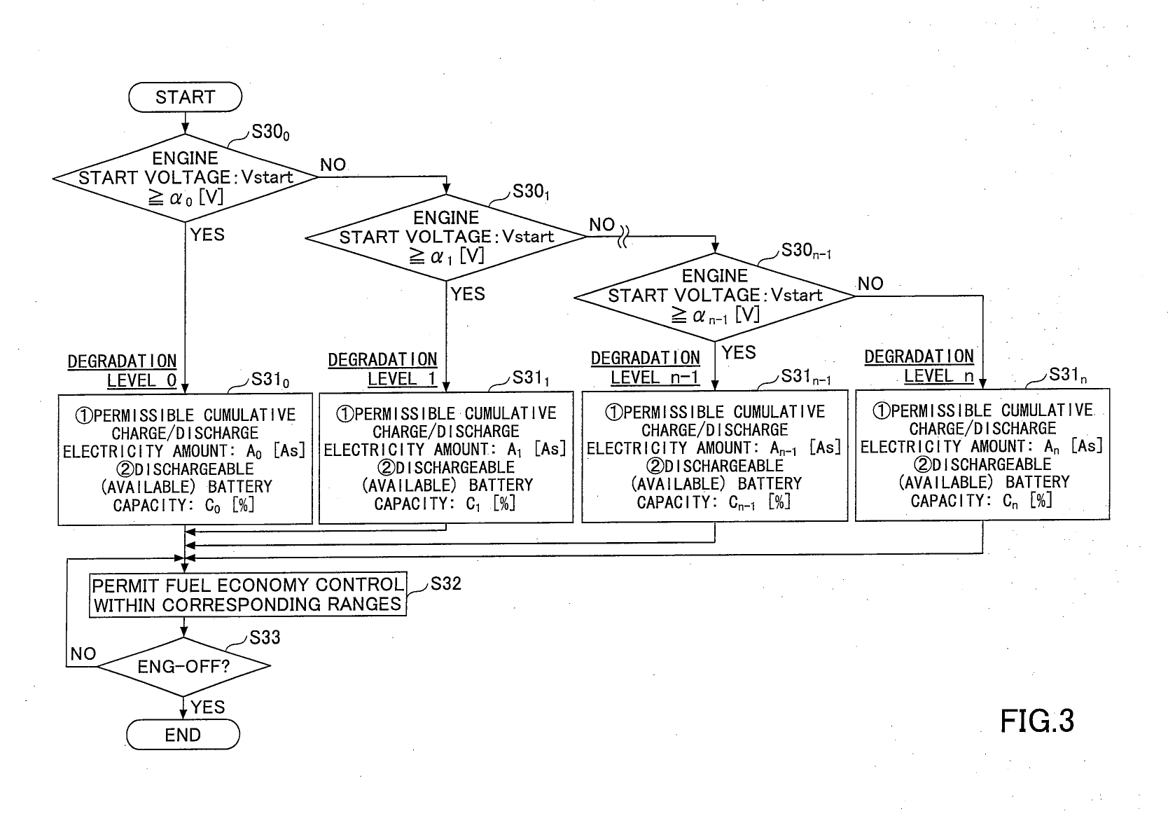

FIG. 3 is an example of a flowchart of a process executed by the charge control ECU 10. The process routine illustrated in FIG. 3 is initiated when the ignition switch is turned on, and then is executed repeatedly at a predetermined cycle until the ignition switch is turned off.

In step S30₀, the battery state determination part 12 detects the battery voltage (engine start voltage Vstart) at the time of the engine start based on the information from the voltage sensor 64, and determines whether the engine start voltage Vstart is greater than or equal to a predetermined value α0. The predetermined value α0 may correspond to a minimum value of a possible range of the engine start voltage Vstart of the battery 60 at the degradation level “0”. It is noted that the degradation level “0” may correspond to a brand new state of the battery 60 or the like. If the engine start voltage Vstart is greater than or equal to the predetermined value α0, the process routine goes to step S31₀, otherwise the process goes to step S30₁.

In step S30₁, the battery state determination part 12 determines whether the engine start voltage Vstart is greater than or equal to a predetermined value α1. The predetermined value α1 is smaller than the predetermined value α0, and may correspond to a minimum value of a possible range of the engine start voltage Vstart of the battery 60 at the degradation level “1”. If the engine start voltage Vstart is greater than or equal to the predetermined value α1, the process routine goes to step S31₁, otherwise the process goes to step S31₂ (not illustrated).

In step S30ₙ₋₁, the battery state determination part 12 determines whether the engine start voltage Vstart is greater than or equal to a predetermined value αₙ₋₁. The predetermined value αₙ₋₁ is smaller than a predetermined value αₙ₋₂, and may correspond to a minimum value of a possible range of the engine start voltage Vstart of the battery 60 at the degradation level “n−1”. If the engine start voltage Vstart is greater than or equal to the predetermined value αₙ₋₁, the process routine goes to step S31ₙ₋₁, otherwise the process goes to step S31ₙ.

In step S31₀, the fuel economy prevention part 18 sets two thresholds, that is to say, a permissible cumulative charge/discharge electricity amount A₀ [As] and a dischargeable (available) battery capacity C₀ [%]. When the process at step S31₀ is terminated, the process routine goes to step S32. The permissible cumulative charge/discharge electricity amount A₀ corresponds to an upper limit of the cumulative charge/discharge electricity amount that is permissible with respect to the battery 60 at the degradation level “0” in terms of life preservation. The dischargeable battery capacity C₀ corresponds to an upper limit of the dischargeable battery capacity that is permissible with respect to the battery 60 at the degradation level “0” in terms of life preservation.

In step S31₁, the fuel economy prevention part 18 sets two thresholds, that is to say, a permissible cumulative charge/discharge electricity amount A₁ and a dischargeable (available) battery capacity C₁. When the process at step S31₁ is terminated, the process routine goes to step S32. The permissible cumulative charge/discharge electricity amount A₁ corresponds to an upper limit of the cumulative charge/discharge electricity amount that is permissible with respect to the battery 60 at the degradation level “1” in terms of life preservation. The permissible cumulative charge/discharge electricity amount A₁ is smaller than the permissible cumulative charge/discharge electricity amount A₀. This is because making the permissible cumulative charge/discharge electricity amount be smaller as the degradation degree of the battery 60 becomes greater contributes to the life reservation. The dischargeable battery capacity C₁ corresponds to an upper limit of the dischargeable battery capacity that is permissible with respect to the battery 60 at the degradation level “1” in terms of life preservation. The dischargeable battery capacity C₁ is smaller than the dischargeable battery capacity C₀. This is because making the dischargeable battery capacity be smaller as the degradation degree of the battery 60 becomes greater contributes to the life reservation.

In step S31ₙ₋₁, the fuel economy prevention part 18 sets two thresholds, that is to say, a permissible cumulative charge/discharge electricity amount Aₙ₋₁ and a dischargeable (available) battery capacity Cₙ₋₁. When the process at step S31ₙ₋₁ is terminated, the process routine goes to step S32. The permissible cumulative charge/discharge electricity amount Aₙ₋₁ corresponds to an upper limit of the cumulative charge/discharge electricity amount that is permissible with respect to the battery 60 at the degradation level “n−1” in terms of life preservation. The permissible cumulative charge/discharge electricity amount Aₙ₋₁ is smaller than the permissible cumulative charge/discharge electricity amount Aₙ₋₂. The dischargeable battery capacity Cₙ₋₁ corresponds to an upper limit of the dischargeable battery capacity that is permissible with respect to the battery 60 at the degradation level “n−1” in terms of life preservation. The dischargeable battery capacity Cₙ₋₁ is smaller than the dischargeable battery capacity Cₙ₋₂.

In step S31ₙ, the fuel economy prevention part 18 sets two thresholds, that is to say, a permissible cumulative charge/discharge electricity amount Aₙ and a dischargeable (available) battery capacity Cₙ. When the process at step S31ₙ is terminated, the process routine goes to step S32. The permissible cumulative charge/discharge electricity amount Aₙ corresponds to an upper limit of the cumulative charge/discharge electricity amount that is permissible with respect to the battery 60 at the degradation level “n” in terms of life preservation. The permissible cumulative charge/discharge electricity amount Aₙ is smaller than the permissible cumulative charge/discharge electricity amount Aₙ₋₁. The dischargeable battery capacity Cₙ corresponds to an upper limit of the dischargeable battery capacity that is permissible with respect to the battery 60 at the degradation level “n” in terms of life preservation. The dischargeable battery capacity Cₙ is smaller than the dischargeable battery capacity Cₙ₋₁. It is noted that the degradation level “n” corresponds to a state of the battery 60 that is necessary to be exchanged or immediately before that state, for example. In this way, the permissible cumulative charge/discharge electricity amount Aₖ and the dischargeable battery capacity Cₖ that differ according to the degradation level (i.e., the engine start voltage) are set. In other words, the permissible cumulative charge/discharge electricity amount Aₖ and the dischargeable battery capacity Cₖ are varied such that the permissible cumulative charge/discharge electricity amount Aₖ and the dischargeable battery capacity Cₖ become smaller as the degradation level “k” becomes greater (i.e., the engine start voltage becomes smaller).

In step S32, the fuel economy prevention part 18 permits the fuel economy control (the charge control and the idling stop control) within the corresponding ranges of the permissible cumulative charge/discharge electricity amount Aₖ and the dischargeable battery capacity Cₖ that are set in step S30ₖ (k is one of 0 through n). In other words, the fuel economy prevention part 18 permits the executions of the fuel economy control (the charge control and the idling stop control) until the cumulative charge/discharge electricity amount exceeds the permissible cumulative charge/discharge electricity amount Aₖ or a decreased amount of the battery capacity exceeds the dischargeable battery capacity Cₖ. Specifically, the fuel economy prevention part 18 determines whether the latest cumulative charge/discharge electricity amount (the cumulative charge/discharge electricity amount from the time of the ignition switch ON event this time) calculated by the charge/discharge amount calculation part 15 exceeds the permissible cumulative charge/discharge electricity amount Aₖ. Further, the fuel economy prevention part 18 calculates, based on the latest SOC of the battery 60 calculated by the battery capacity calculation part 14, the decreased amount of the battery capacity from the time of the ignition switch ON event this time, and determines whether the calculated decreased amount of the battery capacity exceeds the dischargeable battery capacity Cₖ. If any one of these determination results is affirmative, the fuel economy prevention part 18 prevents the fuel economy control, and otherwise, the fuel economy prevention part 18 permits the fuel economy control. It is noted that, in this embodiment, the fuel economy control is prevented when the cumulative charge/discharge electricity amount exceeds the permissible cumulative charge/discharge electricity amount Aₖ or the decreased amount of the battery capacity exceeds the dischargeable battery capacity Cₖ; however, the fuel economy control may be prevented when the cumulative charge/discharge electricity amount exceeds the permissible cumulative charge/discharge electricity amount Aₖ and the decreased amount of the battery capacity exceeds the dischargeable battery capacity Cₖ. Further, only the determination whether the cumulative charge/discharge electricity amount exceeds the permissible cumulative charge/discharge electricity amount Aₖ may be used, or only the determination whether the decreased amount of the battery capacity exceeds the dischargeable battery capacity Cₖ may be used. In other words, one of the determination regarding the cumulative charge/discharge electricity amount and the determination regarding the decreased amount of the battery capacity may be omitted.

It is noted that, when the fuel economy prevention part 18 prevents the fuel economy control, the fuel economy prevention part 18 may transmit information representing that event (prevention instruction) to the generation voltage instruction part 16 and the idling stop control ECU 30. This process may be implemented by setting a fuel economy control prevention flag in its ON state, for example.

The process of step S32 is repeated at a predetermined cycle until the ignition switch is turned off (the determination result of step S33 becomes affirmative). However, if the fuel economy control is prevented in step S32, the process routine may end immediately without waiting for the ignition switch OFF event. In other words, the prevented state continues until the ignition switch is turned off, and thus the prevented state is not canceled until the ignition switch is turned off.

According to the process illustrated in FIG. 3, the permissible cumulative charge/discharge electricity amount and the dischargeable battery capacity are varied in a stepwise manner according to the degradation level of the battery 60, it becomes possible to preserve the life of the battery 60 according to the degradation level of the battery 60. Because the fuel economy control is prevented more easily as the degradation level of the battery 60 becomes higher, it becomes possible to preserve the life of the battery 60 even if the degradation level of the battery 60 is high. Further, because the fuel economy control is permitted as usual until the cumulative charge/discharge electricity amount exceeds the permissible cumulative charge/discharge electricity amount or the decreased amount of the battery capacity exceeds the dischargeable battery capacity, the fuel economy control can be performed in an ordinary manner when it is performed, which enables efficiently increasing the fuel economy. In other words, because a control logic of the fuel economy control itself is not changed according to the degradation level of the battery 60, the way of performing the fuel economy control is not changed according to the degradation level of the battery 60. Specifically, in the case of the charge control, regardless of whether the degradation level is “0” or “n”, in the constant vehicle speed state, the alternator 40 is controlled such that the SOC of the battery 60 is kept at a constant value α, in the accelerated state, the electric power generation of the alternator 40 is stopped, in the decelerated state, the electric power regenerating operation of the alternator 40 is performed in an ordinary manner, and, in the vehicle stop state, the idling stop control is in an ordinary manner.

It is noted that, in the case where the battery 60 is a lead acid battery, the life of the battery 60 is preserved most effectively if the battery 60 is used while being kept at the full charged state. However, keeping the battery 60 at the full charged state requires the alternator 40 to constantly generate electricity (with a constant electric power generation voltage), which is not desirable in terms of fuel economy. Therefore, the charge control described above is performed. On the other hand, when the charge control is performed, the SOC of the battery 60 deviates from its full charged state for increased time and may vary relatively greatly, which is not desirable in terms of the life of the battery 60. Regarding this, according to the process illustrated in FIG. 3, the charge control and the idling stop control in their ordinary manner are permitted until the cumulative charge/discharge electricity amount exceeds the permissible cumulative charge/discharge electricity amount or the decreased amount of the battery capacity exceeds the dischargeable battery capacity, which increases compatibility between the improved fuel economy and the preserved life of the battery 60.

It is noted that, with respect to the process illustrated in FIG. 3, when the cumulative charge/discharge electricity amount exceeds the permissible cumulative charge/discharge electricity amount or the decreased amount of the battery capacity exceeds the dischargeable battery capacity during a period in which the idling stop control is performed (i.e., the engine 42 is stopped), the engine 42 may be restarted immediately at that time. In this case, the idling stop control is not permitted again during the same trip.

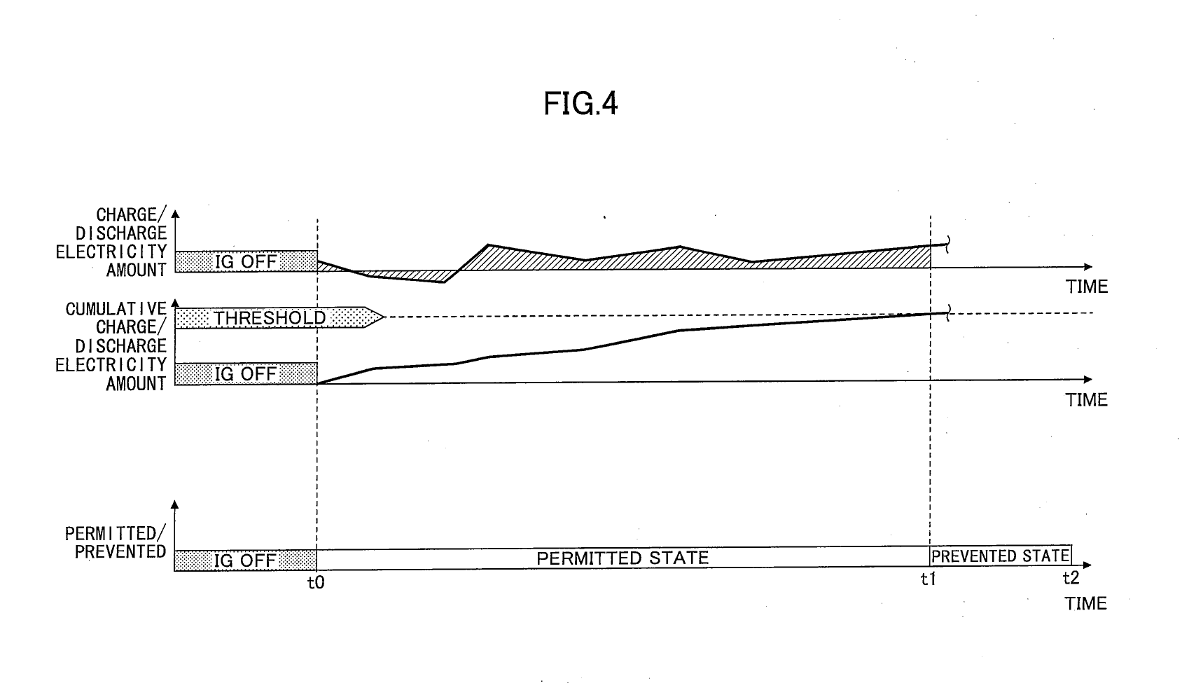

FIG. 4 is a diagram explaining a process illustrated in FIG. 3 in which time-series data of the charge/discharge amount, the cumulative charge/discharge electricity amount, and the permitted/prevented state of the fuel economy control are illustrated from the upper side in this order.

In the example illustrated in FIG. 4, the ignition switch is turned on at time t0, and thus the calculation of the cumulative charge/discharge electricity amount is started. The threshold in the drawing corresponds to the permissible cumulative charge/discharge electricity amount that is set according to the engine start voltage detected at time t0 (at the time of the engine start), as described above. At time t1, the cumulative charge/discharge electricity amount reaches the permissible cumulative charge/discharge electricity amount, and thus the fuel economy control is prevented after time t1. In other words, before time t1, the fuel economy control is permitted by the fuel economy prevention part 18, and thus the charge control and the idling stop control may be performed. However, even if the charge control and the idling stop control are permitted by the fuel economy prevention part 18, the fuel economy control may be prevented when a hardware resource (the alternator 40, for example) fails or a refresh charge is being performed, etc. In other words, the fuel economy control may be prevented or limited by factors other than the fuel economy prevention part 18. After the fuel economy control is prevented at time t1, the prevented state of the fuel economy control is continued until the ignition switch is turned off at time t2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention. Further, all or part of the components of the embodiments described above can be combined.

For example, in the embodiments described above, the battery state determination part 12 determines the degradation degree of the battery 60 based on the engine start voltage; however, the degradation degree of the battery 60 may be determined based on the decreased amount of the battery voltage at the time of the engine start. Further, the degradation degree of the battery 60 may be determined based on a changed amount of the SOC of the battery 60 when the battery 60 is charged for a predetermined period, a temperature histogram, a capacity histogram, etc.

Further, in the embodiments described above, the cumulative charge/discharge electricity amount is considered in determining whether a fuel economy control prevention condition is met; however, instead of the cumulative charge/discharge electricity amount, only the time-integrated value of the charge current or the time-integrated value of the discharge current may be considered. Further, instead of or in addition to the cumulative charge/discharge electricity amount, a cumulative value of a period during which the charge control is performed. The cumulative value of a period during which the charge control is performed may correspond to a cumulative value of a period during which the charge control or the idling stop control is performed.

Further, in the embodiments described above, in order to determine whether the fuel economy control prevention condition is met, it is determined whether the decreased amount of the battery capacity exceeds the dischargeable battery capacity; however, instead of or in addition to the determination, it may be determined whether the SOC of the battery 60 becomes below a predetermined threshold. In this case, the predetermined threshold may be varied such that the predetermined threshold becomes higher as the degradation degree of the battery 60 becomes higher.

Further, in the embodiments described above, in order to determine whether the fuel economy control prevention condition is met, it is determined whether the number of the executions of the idling stop control counted from the ignition ON event exceeds a permissible number. In this case, the permissible number may be varied such that the permissible number becomes smaller as the degradation degree of the battery 60 becomes higher.

Further, in the embodiments described above, the process illustrated in FIG. 3 is executed for a single trip from the ignition ON event to ignition OFF event; however, if the engine 42 is stopped by the idling stop control during a single trip, the determination result of step S33 may be affirmative, and the processes from step S30₀ may be started based on the battery voltage at the time of the engine restart. In other words, the determination result of step S33 may be affirmative even if the engine 42 is stopped by the idling stop control. In this case, the cumulative charge/discharge electricity amount and the decreased amount of the battery capacity may be cleared to be an initial value 0.

The present application is based on Japanese Priority Application No. 2013-261737, filed on Dec. 18, 2013, the entire contents of which are hereby incorporated by reference.

What is claimed is:

1. A vehicle control apparatus, comprising:
a sensor that obtains information representing a status of a degradation degree of a battery;
a controller that permits at least one of a charge control and an idling stop control such that the degradation degree of the battery does not affect a way of performing the control, until a predetermined parameter that affects a life of the battery meets a control prevention condition, the charge control controlling an alternator according to a travel state of a vehicle, wherein
the control prevention condition is varied according to the degradation degree of the battery such that the control prevention condition becomes more difficult to be met as the degradation degree of the battery becomes higher.

2. The vehicle control apparatus of claim 1, wherein the predetermined parameter includes at least one of
a time-integrated value of an absolute value of a charge current to the battery and an absolute value of a discharge current from the battery after an ignition switch has been turned on; and
a decreased amount of a SOC (State of Charge) of the battery after the ignition switch has been turned on.

3. The vehicle control apparatus of claim 2, wherein the control prevention condition is met when the time-integrated value exceeds a first predetermined value and the decreased amount of a SOC exceeds a second predetermined value, and
The first predetermined value and the second predetermined value are varied such that the first predetermined value and the second predetermined value becomes smaller as the degradation degree of the battery becomes higher.

4. The vehicle control apparatus of claim 1, wherein the sensor includes a voltage sensor for detecting a voltage of the battery, and
the controller determines the degradation degree of the battery based on the voltage of the battery at a time of an engine start.
